(19) United States
(12) Patent Application Publication
(10) Pub. No.: US 2022/0259357 A1
(43) Pub. Date: Aug. 18, 2022

(54) HYBRID FUNCTIONAL FLUOROPOLYMERS

(71) Applicant: Arkema Inc., King of Prussia, PA (US)

(72) Inventors: Yujie LIU, King of Prussia, PA (US); Jiaxin J. GE, King of Prussia, PA (US)

(21) Appl. No.: 17/618,917

(22) PCT Filed: Jun. 24, 2020
(86) PCT No.: PCT/US2020/039307

§ 371 Date: Dec. 14, 2021

Related U.S. Application Data
(60) Provisional application No. 62/866,314, filed on Jun. 25, 2019.
(60) Provisional application No. 62/952,610, filed on Dec. 23, 2019.

(51) Int. Cl. C08F 259/08

(52) U.S. Cl. CPC C08F 259/08

(57) ABSTRACT

A silane functionalized fluoropolymer-acrylic composition is disclosed.

This application claims priority to U.S. provisional application 62/866,314 filed Jun. 25, 2019 and 62/952,610 filed Dec. 23, 2019, which are both herein incorporated by reference.

### FIELD OF THE INVENTION

The invention relates to a composition containing a silane functionalized acrylic modified fluoropolymer.

### BACKGROUND OF THE INVENTION

Fluoropolymers are traditionally used for applications requiring special properties, such as low surface energy, high resistance to chemical attack, aging resistance, and electrochemical stability. However, these advantageous properties also make fluoropolymers difficult to work with and limits their applications. For example, the lack of functional groups on the fluoropolymers makes them difficult: to adhere to substrates, to facilitate cross-linking, to provide sites for subsequent chemical modification, to be wetted by water, and to add hydrophilic characteristics. There is a need for fluorinated polymers having modified properties, such as functional groups, which can augment their properties.

It is difficult to add functional monomer units directly into the polymerizing polymer backbone of a fluoropolymer, especially in a random manner, due to the aggressive nature of the fluorine-containing free radicals. Functionality has been added by several means, such as, by direct copolymerization of a functional monomer with the fluoromonomers, and by a post-polymerization grafting mechanism, such as the grafting of maleic anhydride onto a polyvinylidene fluoride homopolymer or copolymer, as described in U.S. Pat. No. 7,241,817, to form KYNAR® ADX resins available from Arkema Inc. (Pennsylvania, USA). WO 2013/110740 and U.S. Pat. No. 7,351,498 further describe functionalization of a fluoropolymer by monomer grafting or by copolymerization.

U.S. Pat. No. 5,415,958 discloses copolymerization of vinylidene fluoride with an unsaturated dibasic acid monoester polar monomer, to introduce carbonyl groups to the backbone of PVDF in order to improve its adhesion to different substrates.

### SUMMARY OF INVENTION

A composition comprising a fluoropolymer-acrylic hydrid polymer post modified with silane chemistry is disclosed. The post modification with provided for functionality that unmodified AMF polymers do not possess. The composition is synthesized by emulsion polymerization of acrylate/methacrylate monomers using a fluoropolymer latex as seed providing a fluoropolymer acrylic hybrid composition. The acrylic portion of the acrylic modified fluoropolymer is capable of cross-linking. The hybrid polymer is then dissolved in solvent and reacted with a functionalized silane to produce a silane functionalized hybrid acrylic modified fluoropolymer composition. The acrylic portion of the acrylic modified fluoropolymer is capable of cross-linking as well as the portion of functional silane groups. It can be self-crosslinking or can crosslink using a crosslinking agent.

The silane modified fluoropolymer-acrylic hybrid polymer composition is synthesized in a step-wise process. The first step is the emulsion polymerization of (meth)acrylate monomers using fluoropolymer latex as seed followed by a post polymerization modification. The process is analogous to that described in US patents U.S. Pat. Nos. 5,349,003, 6,680,357 and US 2011/0118403. The fluoropolymer-acrylic hybrid polymer is formed in a process wherein a fluoropolymer is employed as seed in a polymerization of acrylic polymers from acrylic monomers and monomers copolymerizable with acrylic monomers to form what will be referred to herein as acrylic modified fluoropolymer, “AMF polymers”. In the present invention, the AMF polymers have, in the acrylic portion, functional groups capable of reacting with other functional groups. The AMF polymer is then dissolved in solvent and post-modified with functionalized silane to provide the silane functionalized acrylic modified fluoropolymer of the invention.

The invention relates to a composition containing a crosslinkable fluoropolymer-acrylic composition synthesized by emulsion polymerization of acrylate/methacrylate monomers using fluoropolymer latex as seed and then post modified with functionalized silane.

The silane functionalized acrylic modified fluoropolymer composition provides for adhesion of at least 10 N/m, preferably at least 15 N/m. and at the same time the swelling ratio of less than 500%, preferably less than 410%. Lower swelling equates to better chemical resistance. Generally, the swelling ratio is greater than 100%. Generally the adhesion is from than 15 N/m to 200 N/m.

### DETAILED DESCRIPTION

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

All references listed in this application are incorporated herein by reference. All percentages in a composition are weight percent, unless otherwise indicated.

Unless otherwise stated, molecular weight is a weight average molecular weight as measured by GPC, using a polymethyl methacrylate standard. In cases where the polymer contains some cross-linking, and GPC cannot be applied due to an insoluble polymer fraction, soluble fraction/gel fraction or soluble faction molecular weight after extraction from gel is used. Crystallinity and melting temperature are measure by DSC as described in ASTM D3418 at heating rate of 10 C/min. Melt viscosity is measured in accordance with ASTM D3835 at 230° C. expressed in k Poise @100 Sec⁻¹.

The term “polymer” is used to mean both homopolymers, copolymers and terpolymers (three or more monomer units), unless otherwise stated. Copolymer” is used to mean a polymer having two or more different monomer units. For example, as used herein, “PVDF” and “polyvinylidene fluoride” is used to connote both the homopolymer and copolymers, unless specifically noted otherwise. The polymers may be homogeneous, heterogeneous, and may have a gradient distribution of co-monomer units.

The term “binder” is used to refer to the composition comprising the silane functionalized crosslinkable fluoropolymer acrylic hybrid polymer or a silane functionalized fluoropolymer acrylic copolymer that contains functionality that can cross link, that can be coated onto a substrate.

Crosslinkable means that the acrylic portion of the fluoropolymer acrylic hybrid polymer has functionality in the monomers that can crosslink or contains a crosslinking agent.

By fluoropolymer-acrylic hybrid composition means a composition in which an acrylic has be polymerized in the presence of a fluoropolymer seed. Such hybrid composition are described in US patents U.S. Pat. Nos. 5,349,003, 6,680,357 and US 2011/0118403

Acrylic encompasses both acrylic and meth acrylic monomers unless otherwise specified.

Dry adhesion: To develop dry adhesion, the crosslinkable fluoropolymer acrylic resin binder must during a casting and/or the compression step adhere to a substrate, such as the electrode or separator. In a solution based coating, the polymer is dissolved in a solvent and coats the substrate. Generally, the higher adhesion the better. Wet adhesion relates to the fluoropolymer swollen in electrolyte. The electrolyte tends to soften the fluoropolymer in a manner similar to that caused by a plasticizer.

The composition of the present invention is a curable composition (crosslinkable) comprising an silane functionalized acrylic modified fluoropolymer preferably based on a polyvinylidene fluoride polymer selected from the group polyvinylidene fluoride homopolymer and polyvinylidene fluoride-hexafluoropropylene copolymer wherein the acrylic phase contains monomer residues having functional groups whereby the acrylic phase can become crosslinked, entering into a crosslinking reaction.

The silane functional fluoropolymer-acrylic composition provides enhanced properties compared to the unmodified AMF, such as increased adhesion and lower swelling. The invention may provide increased hydrophilic characteristics. The composition of the invention may be used in applications benefiting from a functional fluoropolymer including as binders in electrode-forming compositions and separator compositions and coatings.

The invention further relates to a formulation comprising the crosslinkable fluoropolymer-acrylic composition in a solvent. The solvent is preferably chosen from: water, n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC) or ethyl methyl carbonate (EMC).

According to this invention, there is provided a solvent based polymer composition comprising a silane functionalized fluoropolymer acrylic hybrid polymer composition.

The acrylic portion of the silane functionalized acrylic modified fluoropolymer has at least one monomer selected from the group consisting of alkyl acrylates whose alkyl groups have 1-18 carbon atoms and alkyl methacrylates whose alkyl groups have 1-18 carbon atoms and an ethylenically unsaturated compound copolymerizable with the alkyl acrylates and the alkyl methacrylates.

### Seed Fluoropolymers

The fluoropolymers used in the invention as seed for the acrylic polymerization are formed primarily of fluoromonomers. The term “fluoromonomer” or the expression “fluorinated monomer” means a polymerizable alkene which contains at least one fluorine atom, fluoroalkyl group, or fluoroalkoxy group attached to the double bond of the alkene that undergoes polymerization. The term “fluoropolymer” means a polymer formed by the polymerization of at least one fluoromonomer, and it is inclusive of homopolymers, copolymers, terpolymers and higher polymers which are thermoplastic in their nature, meaning they are capable of being formed into useful pieces by flowing upon the application of heat, such as is done in molding and extrusion processes. The fluoropolymer preferably contains at least 50 mole percent of one or more fluoromonomers.

Fluoromonomers useful in the practice of the invention include, for example, vinylidenefluoride (VDF), tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole, and combinations thereof.

The fluoropolymer used as seed particles is preferably a vinylidene fluoride polymer obtained by emulsion-polymerization. Such an aqueous vinylidene fluoride polymer dispersion can be produced by a conventional emulsion polymerization method, for example, by emulsion-polymerizing the starting monomers in an aqueous medium in the presence of a polymerization initiator, this process is known in the art. Specific examples of the vinylidene fluoride polymer obtained by emulsion-polymerization include vinylidene fluoride homopolymer and copolymers of (1) vinylidene fluoride and (2) a fluorine-containing ethylenically unsaturated compound (e.g. tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole, perfluoroacrylic acid or the like), a fluorine-free ethylenically unsaturated compounds (e.g. cyclohexyl vinyl ether, hydroxyethyl vinyl ether or the like), a fluorine-free diene compound (e.g. butadiene, isoprene, chloroprene or the like) or the like, all of them being copolymerizable with vinylidene fluoride. Of these, preferred are vinylidene fluoride homopolymer, vinylidene fluoride/tetrafluoroethylene copolymer, vinylidene fluoride/hexafluoropropylene copolymer, vinylidene fluoride/tetrafluoroethylene/hexafluoropropylene copolymer, etc.

Especially preferred fluoropolymers are homopolymers of VDF, and copolymers of VDF with HFP, TFE or CTFE, comprising from about 50 to about 99 weight percent VDF, more preferably from about 70 to about 99 weight percent VDF. Especially preferred copolymers are copolymers of VDF and HFP where the weight percent of VDF in the copolymer is from 50 to 99 weight percent, preferably from 65 to 95 weight percent based on total monomers in the copolymer. In one preferred embodiment of a VDF/HFP copolymer the weight percent of HFP is from 5 to 30%, preferably from 8 to 25% based on the total monomer in the polymer.

Especially preferred terpolymers are the terpolymer of VDF, HFP and TFE, and the terpolymer of VDF, trifluoroethylene, and TFE. The especially preferred terpolymers have at least 10 weight percent VDF, and the other comonomers may be present in varying portions.

The fluoropolymer preferably has a high molecular weight. By high molecular weight, as used herein, is meant PVDF having a melt viscosity of greater than 1.0 kilopoise, preferably greater than 5 kilopoise, more preferably greater than 10 kilopoise, according to ASTM method D-3835 measured at 450° F. and 100 sec-1.

The fluoropolymers used in the invention can be made by means known in the art, such as by an emulsion, suspension, solution, or supercritical CO2 polymerization process. Preferably, the fluoropolymer is formed by an emulsion process. Preferably, the process is fluoro-surfactant free.

In a preferred embodiment, the fluoropolymer seed contains from 0.1 to 25 weight percent of monomeric units containing functional groups, and preferably from 2 to 20 weight percent, based on the total weight of polymer binder. The functional groups aid in adhesion of the polymer binder, and optional inorganic or organic particles to the separator.

The functional groups of the invention are preferably part of a fluoropolymer, due to the durability of fluoropolymers in the battery environment compared to polyolefins and other thermoplastic binder polymers.

The fluoropolymer seed may be functionalized by copolymerization using 0.1 to 25 weight percent, 0.2 to 20 weight percent, 2 to 20 weight percent, and preferably 0.5 to 15 weight percent, of at least one functional comonomer. The copolymerization could add one or more functional comonomers to the fluoropolymer backbone, or be added by a grafting process. The seed fluoropolymer could also be functionalized by polymerized using from 0.1 to 25 weight percent of one or more low molecular weight polymeric functional chain transfer agents. By low molecular weight is meant a polymer with a degree of polymerization of less than or equal to 1,000, and preferably less than 800. The low molecular weight functional chain transfer agent is a polymer or an oligomer having two or more monomer units, and preferably at three or more monomer units, as for example poly acrylic acid. The residual polymeric chain transfer agents may form a block copolymer having terminal low molecular weight functional blocks. The seed fluoropolymer could have both functional comonomer and residual functional polymeric chain transfer agents. By functional polymeric chain transfer agents, as used in the invention, is meant that the low molecular weight polymeric chain transfer agent contains one or more different functional groups.

The useful functional comonomers generally contain polar groups, or are high surface energy. Examples of some useful comonomers include, but are not limited to vinyl acetate, 2,3,3,3-tetrafluoropropene (HFO-1234yf), 2,3,3 trifluoropropene, hexafluoropropene (HFP), and 2-chloro-1-1-difluoroethylene (R-1122). HFP provides good adhesion. Phosphate (meth)acrylates, (meth) acrylic acid, and hydroxyl-functional (meth)acrylic comonomers could also be used as the functional comonomer. Preferably, the functional commoner is hexafluoropropene (HFP).

### Acrylic Portion

The Silane functionalized AMF polymer contains an acrylic portion. The acrylic portion is obtained by emulsion-polymerizing 5-95 parts by weight of a monomer mixture comprising at least one monomer selected from the group consisting of alkyl acrylates whose alkyl groups have 1-18 carbon atoms and alkyl methacrylates whose alkyl groups have 1-18 carbon atoms and an ethylenically unsaturated compound copolymerizable with the alkyl acrylates and the alkyl methacrylates, in an aqueous medium in the presence of 100 parts by weight of particles of a vinylidene fluoride polymer. The acrylic portion contains at least one monomer having a functional group—, preferably —COOH or —OH functional groups or amide. Preferably, at least 1 mol % of the acrylic monomers contain a functional group, more preferably at least 2 mol % of the acrylic monomer contain a functional group. In some embodiments more than 4 mol % and preferably more than 5 mol % or more than 10% of the acrylic monomers contain a functional group. Preferably, no more than 50 mol %. Preferably less than 30 mol % of the acrylic monomers are functionalized.

The alkyl acrylate with an alkyl group having 1-18 carbon atoms, used as one monomer to be emulsion-polymerized in the presence of the vinylidene fluoride polymer particles, includes, for example, methyl acrylate, ethyl acrylate, propyl acrylate, n-butyl acrylate, isobutyl acrylate, amyl acrylate, isoamyl acrylate, hexyl acrylate, 2-ethylhexyl acrylate, diacetone acrylamide, lauryl acrylate and the like. Of these, alkyl acrylates with an alkyl group having 1-8 carbon atoms are preferred, and alkyl acrylates with an alkyl group having 1-5 carbon atoms are more preferable. The alkyl methacrylate with an alkyl group having 1-18 carbon atoms, used as the other monomer to be emulsion-polymerized, includes, for example, methyl methacrylate, ethyl methacrylate, propyl methacrylate, n-butyl methacrylate, isobutyl methacrylate, amyl methacrylate, isoamyl methacrylate, hexyl methacrylate, lauryl methacrylate and the like. Of these, alkyl methacrylates with an alkyl group having 1-8 carbon atoms are preferred, and alkyl methacrylates with an alkyl group having 1-5 carbon atoms are more preferable. These compounds (alkyl acrylate and alkyl methacrylate) may be used alone or in admixture of two or more.

The ethylenically unsaturated compound copolymerizable with the alkyl acrylate and the alkyl methacrylate includes a functional group-containing monomer copolymerizable with the alkyl acrylate and the alkyl methacrylate.

The functional group-containing monomers include, for example, α,β-unsaturated carboxylic acids such as acrylic acid, methacrylic acid, fumaric acid, crotonic acid, itaconic acid and the like; vinyl ester compounds such as vinyl acetate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters such as 2-hydroxyethyl acrylate, N-dialkylaminoethyl acrylate, glycidyl acrylate, fluoroalkyl acrylate and the like; methacrylic acid esters such as dialkylaminoethyl methacrylate, fluoroalkyl methacrylate, 2-hydroxyethyl methacrylate, glycidyl methacrylate, ethylene glycol dimethacrylate and the like; and alkenyl glycidyl ether compounds such as allyl glycidyl ether and the like. Of these, preferred are acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds may be used alone or in admixture of two or more.

It is preferable that the functional monomers be used in a proportion of less than 50% by weight based on the weight of the acrylate monomer mixture. The acrylate and/or methacrylate monomers not containing functional groups capable of entering into crosslinking reactions after polymerization should be greater than 50%, preferably be 70 or greater weight percent of the total monomer mixture, and more preferably, should be above 90 weight percent.

When both the alkyl acrylate and the alkyl methacrylate are used, the proportions of these two esters are not critical and can be appropriately varied depending upon the desired properties of the resulting fluorine-containing polymer. Those of skill in the art will also recognize that any of the known acrylic monomers and ethylenically unsaturated monomers known to be copolymerizable with acrylic monomers may be substituted as long as one such monomer is included which contains functional groups capable of entering into crosslinking reactions. With the proviso that the major portion of the monomers must be selected from acrylic esters and methacrylic esters and at least one of the remaining selected monomers must be capable of entering into a crosslinking reaction.

### Cross Linkers

The acrylic modified fluoropolymer resin is crosslinkable. The acrylic portion may crosslink either through self-condensation of its functional groups or by way of a crosslinking agent. Any typical crosslinking agent can be used. Non-limiting examples of crosslinking agents include, but are not limited to, isocyanates, diamines, adipic acid, dihydrazide, and combinations thereof.

### Emulsion Polymerization

The aqueous fluoropolymer-acrylic composition can be obtained by emulsion-polymerizing 5-100 parts by weight, particularly preferably 5 to 95, preferably 20-90 parts by weight, of the acrylic monomer(s) mentioned above, in an aqueous medium in the presence of 100 parts by weight of the vinylidene fluoride polymer particles mentioned above. The emulsion-polymerization can be effected under ordinary emulsion polymerization conditions. The emulsion polymerization process is known in the art. The emulsion-polymerization using the fluoropolymer particle, preferably vinylidene fluoride polymer particles, as seed particles can be effected according to a known method, for example, a method wherein the whole amount of the monomers is fed into the reaction system at one time in the presence of fluoropolymer particle, preferably vinylidene fluoride polymer particles, a method wherein part of the monomers are fed and reacted and then the rest of the monomers is fed continuously or in portions, a method wherein the whole amount of the monomers is fed continuously, or a method wherein the fluoro polymer particles are added in portions or continuously while allowing the monomers to react.

The fluoropolymer particles, preferably vinylidene fluoride polymer particles may be added in any state to the polymerization system as long as they are dispersed in an aqueous medium in the form of particles. Since the vinylidene fluoride polymer is usually produced as an aqueous dispersion, it is convenient that the aqueous dispersion as produced be used as seed particles. The particle diameters of the fluoropolymer particle, preferably vinylidene fluoride polymer particles, may vary depending upon the diameters of polymer particles present in an objective aqueous dispersion of said polymer but ordinarily is in the range of preferably 0.04-2.9 microns. In a preferred embodiment, the diameter of the polymer particles is preferably 50 nm to 700 nm.

It is thought that the monomer mixture is mostly absorbed or adsorbed by the fluoropolymer particle, preferably vinylidene fluoride polymer particles and polymerized while swelling the particles.

The average particle diameter of the fluorine-containing polymer in the aqueous dispersion of said polymer according to this invention is 0.05-3 μm, preferably 0.05-1 μm, more preferably 0.1-1 μm. When the average particle diameter is less than 0.05 μm, the resulting aqueous dispersion has a high viscosity; accordingly, it is impossible to obtain an aqueous dispersion of a high solid content, and a coagulation product is formed when the mechanical shear conditions are severe depending upon the use conditions. When the average particle diameter is more than 3 μm, the aqueous dispersion has poor storage stability.

Though the aqueous dispersion containing the crosslinkable AMF polymer can be used as it is, it may also be mixed with additives and then used.

The product of the polymerization is a latex, which can be coagulated to isolate the solids, which may then be washed and dried. For solid product, the latex may be coagulated mechanically or by the addition of salts or acids, and then isolated by well-known means such as by filtration. Once isolated, solid product can be purified by washing or other techniques, and it may be dried.

### Silane Functionalization.

The fluoropolymer acrylic hybrid polymer is further functionalized in a post polymerization reaction with a functioned silane to provide a silane functionalized AMF polymer. The weight percent of silane in the silane functionalized AMF polymer is from 15 to 45 weight percent, preferably from 20 to 40 weight percent based on the total weight of the fluoropolymer, the acrylic portion and the functional silane.

In the post polymerization reaction, the acrylic fluoropolymer hybrid polymer is dissolved in a solvent and through hydrolysis-polycondensation reactions is further functionalized with functionalized silane. An acid is preferably used to catalyze the reactions, one such acid is acetic acid other acids may be used. A person of skill in the art understands that other acids will also perform the catalytic function.

Suitable silanes included vinyl functional silanes, amino functional silanes, (methy)acryloxy silanes and acryloxy silanes, ethoxy silanes, methoxy silanes, ureido functional silane, isocyanate functional and mercapto functional silanes. Preferred are the (methy)acryloxy silanes, acryloxy silanes, ethoxy silanes, methoxy silanes.

Example silanes include, but are not limited to, tetra methoxy silane, tetra ethoxy silane (TEOS), 3-methacryloxy propyl trimethoxy silane, 3-methacryloxy propyl triethoxy silane, 3-methacryloxy propylmethyl diethoxy silane, 3-acryloxy propyl triethoxy silane, 3-acryloxy propylmethyl diethoxy silane, ethyl triethoxy silane, vinyltrimethoxysilane, vinyltriethoxysilane, vinyl-tris-(2-methoxyethoxy)silane, vinyltriisopropyloxysilane Octenytrimethoxysilane, 3-methacryloxy propyl methyldimethoxysilane, 3-methacryloxy propyl trimethoxy silane, 3-methacryloxy propyl methyldiethoxysilane, 3-methacryloxy triethoxysilane, 8-methacryloxy octyl trimethoxysilane, 3 acryloxy propyl trimethoxysilane, N-2-(aminoethyl)-3-aminopropylmethyldimethoxysilane, N-2-(aminoethyl)-3-aminopropyltrimethoxysilane, 3-aminopropyltriethoxysilane, 3-aminopropyltrimethoxysilane, N-2-(aminoethyl)-8-aminooctyltrimethoxysilane, 3-trimethoxysilypropyldiethylenetriamine, bis-(3-trimethoxysilylpropyl)amine, 4-amino-3,3-dimethylbutyltrimethoxysilane, 3-aminopropylmethyldiethoxysilane, 3-aminopropylmethyldimethoxysilane, 3-trimethoxysilyl)propylsuccinic anhydride, 3-mercaptopropyltrimethoxysilane, 3-mercaptopropylmethyldimethoxysilaneoxysilane. Combinations of silanes can be used.

Preferred silanes are tetra methoxy silane, tetra ethoxy silane (TEOS), 3-methacryloxy propyl trimethoxy silane, 3-methacryloxy propyl triethoxy silane, 3-methacryloxy propylmethyl diethoxy silane, 3-acryloxy propyl triethoxy silane, 3-acryloxy propylmethyl diethoxy silane, ethyl triethoxy silane, vinyltrimethoxysilane, vinyltriethoxysilane, vinyl-tris-(2-methoxyethoxy)silane, vinyltriisopropyloxysilane Octenytrimethoxysilane, 3-methacryloxy propyl methyldimethoxysilane, 3-methacryloxy propyl trimethoxy silane, 3-methacryloxy propyl methyldiethoxysilane, 3-methacryloxy triethoxysilane, 8-methacryloxy octyl trimethoxysilane, 3 acryloxy propyl trimethoxysilane, and combinations thereof. Combinations of silanes can be used.

In one embodiment of tetraethyl orthosilicate (TEOS) and methacryloxy propyl trimethoxy silane are used in combination.

The epoxy functional silane, such as 3-glycidoxy propyl trimethoxy silane, 3-glycidoxy propylmethyl diethoxy silane are not included in the silanes used in the invention.

### Other Additives

The composition of the invention may optionally include 0 to 15 weight percent based on the polymer, and preferably 0.1 to 10 weight percent of additives, including but not limited to thickeners, pH adjusting agents, anti-settling agents, surfactants, wetting agents, fillers, anti-foaming agents, and fugitive adhesion promoters.

The composition of the invention has excellent dry adhesion. Dry adhesion can be determined by casting a solution of multi-phase polymer on an aluminum foil to form a 3 micron thick solid, unfilled polymer film after drying, and measuring the peel strength.

Wet adhesion can be determined by soaking the 3 micron solid film on aluminum foil in electrolyte solution at 60 C for 72 hours and looking for defects and delamination.

### Use

The silane functionalized fluoropolymer acrylic composition can be applied to a substrate, as a solvent solution, the solvent being chosen among those listed herein.

In one embodiment, said substrate is porous, for example a porous membrane.

The silane functionalized fluoropolymer acrylic composition provides good adhesion to a separator substrate as measure by the Adhesive strength test: Adhesive strength test: Apply a double sided tape onto a thick block (e.g. thickness around 1 cm) of steel plate, attach the uncoated side of aluminum foil in the composite of electrode and coated separator to the double sided tape, and run the 180 degree peel test by peeling off the single sided tape and coated separator. The peel test was run under tension mode, with a load cell of 10 N and peeling speed of 2 mm/min. The adhesion is at least 10 N/m, preferably greater than 15 N/m, preferably greater than 20 N/m and more preferably greater than 30 N/m and at the same time a swelling ratio of less than 500%, preferably 410% or less, and more preferably less than 300%.

Aspects of the Invention

Aspect 1. A composition comprising a fluoropolymer-acrylic hybrid composition modified with functionalized silane, wherein the acrylic portion of the acrylic modified fluoropolymer contains functional groups.

Aspect 2. The composition of aspect 1, wherein the silane modified fluoropolymer-acrylic hybrid composition comprises a fluoropolymer seed, the fluoropolymer seed comprises a vinylidene fluoride polymer preferably having at least 50 weight percent VDF units, preferably at least 70 weight percent VDF units.

Aspect 3. The composition of any one of aspects 1 to 2, wherein the fluoropolymer seed comprises from 3 to 30 wt % hexafluoropropylene units.

Aspect 4. The composition of any one of aspects 1 to 3, wherein the seed comprises a polyvinylidene fluoride-hexafluoropropylene copolymer, wherein the total weight percent of hexafluoropropylene monomeric units in the fluoropolymer-acrylic resin is from 5 to 20%, preferably from 10 to 20 wt % based on the weight of fluoropolymer-acrylic hybrid composition prior to modification by silane.

Aspect 5. The composition of any one of aspects 1 to 4, wherein the total weight percent of acrylic monomeric units in the fluoropolymer-acrylic resin is from 10 to 50 wt %, preferably, from 15 to 40 wt % in the AMF prior to modification by silane.

Aspect 6. The composition of any one of aspects 1 to 5, wherein the acrylic portion contains monomer selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate, allyl glycidyl ether, methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (meth)acrylate, and combination thereof.

Aspect 7. The composition of any one of aspects 1 to 6, wherein the fluoropolymer-acrylic resin is self cross-linking.

Aspect 8. The composition of any one of aspects 1 to 6, wherein the fluoropolymer-acrylic composition comprises a cross-linking agent.

Aspect 9. The composition of aspect 8, wherein the crosslinking agent is selected from the group consisting of isocyanate, diamine, adipic acid, dihydrazide, and combinations thereof.

Aspect 10. The composition of any one of aspects 1 to 9, wherein the silane comprises from 10 to 60 weight percent of the silane modified fluoropolymer-acrylic composition, preferably from 20 to 50 weight percent, more preferably from 20 to 40 weight percent based on the total weight of the silane modified fluoropolymer-acrylic composition.

Aspect 11. The composition of any one of aspects 1 to 10, wherein the silane comprises at least one silane is selected from the group consisting of vinyl functional silanes, amino functional silanes, (methy)acryloxy silanes and acryloxy silanes, ethoxy silanes, methoxy silanes, isocyanate functional and mercapto functional silanes and combination thereof.

Aspect 12. The composition of any one of aspects 1 to 11, wherein the silane comprises at least one silane is selected from the group consisting of tetra methoxy silane, tetra ethoxy silane (TEOS), 3-methacryloxy propyl trimethoxy silane, 3-methacryloxy propyl triethoxy silane, 3-methacryloxy propylmethyl diethoxy silane, 3-acryloxy propyl triethoxy silane, 3-acryloxy propylmethyl diethoxy silane, ethyl triethoxy silane, vinyltrimethoxysilane, vinyltriethoxysilane, vinyl-tris-(2-methoxyethoxy)silane, vinyltriisopropyloxysilane, Octenytrimethoxysilane, 3-methacryloxy propyl methyldimethoxysilane, 3-methacryloxy propyl trimethoxy silane, 3-methacryloxy propyl methyldiethoxysilane, 3-methacryloxy triethoxysilane, 8-methacryloxy octyl trimethoxysilane, 3 acryloxy propyl trimethoxysilane, N-2-(aminoethyl)-3-aminopropylmethyldimethoxysilane, N-2-(aminoethyl)-3-aminopropyltrimethoxysilane, 3-aminopropyltriethoxysilane, 3-aminopropyltrimethoxysilane, N-2-(aminoethyl)-8-aminooctyltrimethoxysilane, 3-trimethoxysilypropyldiethylenetriamine, bis-(3-trimethoxysilylpropyl)amine, 4-amino-3,3-dimethylbutyltrimethoxysilane, 3-aminopropylmethyldiethoxysilane, 3-aminopropylmethyldimethoxysilane, 3-trimethoxysilyl)propylsuccinic anhydride, 3-mercaptopropyltrimethoxysilane, 3-mercaptopropylmethyldimethoxysilaneoxysilane and combinations thereof.

Aspect 13. A method for forming the composition of any one of aspects 1 to 12 comprising
a) providing a fluoropolymer-acrylic hybrid composition containing functional groups,
b) dissolving the AMF in solvent
c) introducing a silane into the dissolved AMF, optionally in the presence of a catalyst,
d) recovering the silane functionalized modified fluoropolymer-acrylic hybrid resin composition.
   wherein the silane functionalized modified fluoropolymer-acrylic hybrid resin comprising from 5 to 30 wt % acrylic monomer units based upon the total weight of the silane modified fluoropolymer-acrylic hybrid resin, wherein the AMF is a composition comprising an acrylic monomer polymerized with a fluoropolymer seed.

Aspect 14. The method of aspect 13 wherein the solvent is selected from the group consisting of n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC), ethyl methyl carbonate (EMC) or combinations thereof.

### EXAMPLES

### Adhesive Strength to Positive Electrode:

Preparation of positive electrode: 27.16 g of Nickel Manganese Cobalt 622 powder as the positive active material, 0.42 g of carbon black powder as the conductive agent, and 0.42 g of polyvinylidene fluoride as binder were mixed in 4.83 g of N-methyl-pyrrolidone. The resultant composition were mixed under high speed, e.g. 2000 rpm. The positive electrode slurry was coated onto aluminum foil, dried in the oven and calendared by press to achieve a positive electrode.

Sample preparation for peel test: The coated separator and positive electrode were cut into shape of 2.5 cm by 5 cm. The adhesive organic layer coated side of the separator was laminated into contact with the positive electrode side. Lamination was carried at 85° C. and 0.62 MPa for 2 min to adhere coated separator to positive electrode. After lamination, attach single sided tape as the backing support layer to the coated separator. Then cut the composite of single sided tape, coated separator, and positive electrode to 1.5 cm by width and 5 cm by length.

Adhesive strength test: Apply a double sided tape (such as 3M's double coated paper tape 410M) onto a thick block (e.g. thickness around 1 cm) of steel plate, attach the uncoated side of aluminum foil in the composite of electrode and coated separator to the double sided tape, and run the 180 degree peel test by peeling off the single sided tape and coated separator. The peel test was run under tension mode, with a load cell of 10 N and peeling speed of 2 mm/min. The trend that the higher the tested adhesion force, the more transferred electrode material to the coated separator would be observed.

Swelling test in electrolyte: Electrolyte consists of ethylene carbonate, dimethyl carbonate, and diethyl carbonate with ratio of 1:1:1 by volume was used. Samples were prepared either by drying from solution with organic solvent or by drying from solution with water. Swelling test was carried at 60° C. with dried samples submerged completely in the electrolyte for 72 hours. Weight of the sample was measured before swelling test (m1) as well as after the swelling test (m2). Then the swelling ratio was characterized as (m2−m1)/m1*100%.

### Example 1

This example demonstrated the preparation of a functional Silane modified crosslinkable AMF polymer. A polyvinylidene fluoride-hexafluoropropylene (PVDF-HFP) copolymer latex was obtained and used as seed to synthesize a latex containing fluoropolymer-acrylic composition using emulsion polymerization process. Solids content of this latex is around 44 wt %. The mass percent of the HFP part in the PVDF-HFP copolymer is around 20 to 22 wt % and the acrylic part is around 30 wt % in total polymer. The acrylic part has a glass transition temperature of 46° C. The PVDF-HFP/hydroxyl functional acrylic copolymers (70/30). 7.22 g crosslinkable AMF was dissolved in 64.9 g cyclopentanone in a reaction vessel with a mechanical stirring speed of 300 rpm at 60° C. overnight. 2.107 g of tetraethyl orthosilicate (TEOS) (from Gelest), 0.952 g of methacryloxy propyl trimethoxy silane (from Gelest), and 0.832 g of methanol (MeOH) were charged into the reaction vessel containing 7.22 g crosslinkable AMF in cyclopentanone near 23° C. with a mechanical stirring speed of 300 rpm. In addition, acetic acid was used as a catalyst at a level of 0.248 g. The polycondensation reaction occurred at 67-69° C. for 2 hours. The uniform solution was transparent and viscous while it was cooled down to ambient temperature and ready for coatings.

The slurry was applied to the porous separator, and dried at 60° C. The dried thickness of the adhesive layer is in the range of 1 to 2 μm. The adhesive strength of separator coated with polymer composition in example 1 to cathode was averaged 118 N/m. The average swelling ratio of the polymer in example 1 in electrolyte was 282%.

### Example 2

This example demonstrated the preparation of a functional Silane modified crosslinkable AMF. A polyvinylidene fluoride-hexafluoropropylene (PVDF-HFP) copolymer latex was obtained and used as seed to synthesize a latex containing fluoropolymer-acrylic composition (“AMF”—acrylic modified fluoropolymer) using emulsion polymerization process. Solids content of this latex is around 44 wt %. The mass percent of the HFP part in the PVDF-HFP copolymer is from 20 to 22 wt % and the acrylic part is from 30 wt % in the total polymer. The acrylic part has a glass transition temperature of 46° C. The AMF was PVDF-HFP/hydroxyl functional acrylic copolymer (70/30 by weight). 10 g crosslinkable AMF was dissolved in 90 g cyclopentanone in a reaction vessel with a mechanical stirring speed of 300 rpm at 60° C. overnight. 3.080 g of tetraethyl orthosilicate (TEOS) (from Gelest), 1.105 g of methacryloxy propyl trimethoxy silane (from Gelest), and 1.055 g of methanol (MeOH) were charged into a reaction vessel with the 10 g crosslinkable AMF in cyclopentanone near 23° C. with the mechanical stirring speed of 310 rpm. In addition, acetic acid was used as a catalyst at a level of 0.167 g. The polycondensation reaction occurred at 68° C. for 2 hours. The uniform solution was transparent and viscous while it was cooled down to ambient temperature and ready for coatings.

Adhesion and Swelling

The slurry was applied to the porous separator, and dried at 60° C. The dried thickness of the adhesive layer is in the range of 1 to 2 μm. The adhesive strength of separator coated with polymer composition in example 2 to cathode was averaged 165 N/m. The average swelling ratio of the polymer in example 2 in electrolyte was 400%.

### Comparative Example 1

A polyvinylidene fluoride-hexafluoropropylene (PVDF-HFP) copolymer was dissolved in cyclopentanone and the solution concentration was 10 wt % by mass. The mass percent of the HFP part in the PVDF-HFP copolymer is around 4 to 6 wt %.

The slurry was applied to the porous separator, and dried at 60° C. oven. The dried thickness of the adhesive layer is in the range of 1 to 2 μm. The adhesive strength of separator coated with material in Comparative Example 1 to cathode was below 3 N/m and the swelling ratio of the material in electrolyte was averaged as 160 wt %.

### Comparative Example 2

A polyvinylidene fluoride-hexafluoropropylene (PVDF-HFP) copolymer latex was used as seed to synthesize a latex containing fluoropolymer-acrylic composition using emulsion polymerization process. Solids content of this latex is around 44 wt %. The mass percent of the HFP part in the PVDF-HFP copolymer is around 20 to 22 wt % and the acrylic part is around 30 wt % in total polymer. The acrylic part has a glass transition temperature of 55° C.

The fluoropolymer-acrylic composition was dissolved in solvent of cyclopentanone and the solution concentration was 10 wt % by mass.

The slurry was applied to the porous separator, and dried at 60° C. oven. The dried thickness of the adhesive layer is in the range of 1 to 2 μm. The adhesive strength of separator coated with fluoropolymer-acrylic composition in Comparative Example 2 to cathode was averaged as 13.7 N/m and the material in Example 2 dissolved in electrolyte.

### Example 3: Crosslinkable AMF Polymer

A polyvinylidene fluoride-hexafluoropropylene (PVDF-HFP) copolymer latex was used as seed to synthesize a latex containing fluoropolymer-acrylic composition using emulsion polymerization process. Solids content of this latex is around 44 wt %. The mass percent of the HFP part in the PVDF-HFP copolymer is around 20 to 22 wt % and the acrylic part is around 30 wt % in total polymer and contained cross linkable groups. The acrylic part has a glass transition temperature of 46° C.

The fluoropolymer-acrylic composition was dissolved in solvent of cyclopentanone and the solution concentration was 10 wt % by mass.

The slurry was applied to the porous separator, and dried at 60° C. oven. The dried thickness of the adhesive layer is in the range of 1 to 2 μm. The adhesive strength of separator coated with the fluoropolymer-acrylic composition to cathode was averaged as 32 N/m and the average swelling ratio of the fluoropolymer-acrylic composition in electrolyte was 900 wt %.

TABLE 1

| | | Adhesion | |
|---|---|---|---|
| | | in Newton | Swelling |
| Example | Composition | meters | % |
| 1 | Silane Functionalized AMF | 118 | 282 |
| 2 | Silane Functionalized AMF | 165 | 400 |
| Comparative 1 | PVDF copolymer 1 | 3 | 160 |
| Comparative 2 | AMF (non-functionized) | 13 | No Swelling- |
| | | | dissolved |
| Comparative 3 | AMF (functionized acrylic | 32 | 900 |
| | portion)- no silane | | |

This shows that the novel composition provides benefits in reduced swelling as compared to the unmodified AMF. Also the difference in adhesion shows that the novel composition has functionalities that the unmodified AMF did not.

1. A composition comprising a silane functionalized fluoropolymer-acrylic hybrid composition comprising an acrylic portion and a fluoropolymer seed, wherein the acrylic portion contains functional groups.

2. The composition of claim 1, the fluoropolymer seed comprises a vinylidene fluoride polymer having at least 50 weight percent VDF units.

3. The composition of claim 1, wherein the fluoropolymer seed comprises from 5 to 30 wt % hexafluoropropylene units.

4. The composition of claim 1, wherein the fluoropolymer seed comprises a polyvinylidene fluoride-hexafluoropropylene copolymer, wherein the total weight percent of hexafluoropropylene monomeric units in the fluoropolymer seed is from 5 to 20 wt %.

5. The composition of claim 1, wherein the total weight percent of acrylic monomeric units in the silane functionalized fluoropolymer-acrylic hybrid composition is from 10 to 50 wt % in the silane functionalized fluoropolymer-acrylic hybrid composition prior to modification by silane.

6. The composition of claim 1, wherein the acrylic portion contains monomer selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate, allyl glycidyl ether, methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (meth)acrylate; and combinations thereof.

7. The composition of claim 1, wherein the silane functionalized fluoropolymer-acrylic hybrid composition is self cross-linking.

8. The composition of claim 1, wherein the composition comprises a cross-linking agent.

9. The composition of claim 8, wherein the crosslinking agent is selected from the group consisting of isocyanate, diamine, adipic acid, dihydrazide and combinations thereof.

10. The composition of claim 1, wherein the silane comprises from 10 to 60 weight percent of the silane functionalized fluoropolymer-acrylic hybrid composition based on the total weight of the silane functionalized fluoropolymer-acrylic hybrid composition.

11. The composition of claim 10, wherein the silane comprises at least one silane selected from the group consisting of vinyl functional silanes, amino functional silanes, (methy)acryloxy silanes, acryloxy silanes, ethoxy silanes, methoxy silanes, isocyanate functional silanes, mercapto functional silanes and combinations thereof.

12. The composition of claim 10, wherein the silane comprises at least one silane is selected from the group consisting of tetra methoxy silane, tetra ethoxy silane (TEOS), 3-methacryloxy propyl trimethoxy silane, 3-methacryloxy propyl triethoxy silane, 3-methacryloxy propylmethyl diethoxy silane, 3-acryloxy propyl triethoxy silane, 3-acryloxy propylmethyl diethoxy silane, ethyl triethoxy silane, vinyltrimethoxysilane, vinyltriethoxysilane, vinyl-tris-(2-methoxyethoxy)silane, vinyltriisopropyloxysilane, Octenytrimethoxysilane, 3-methacryloxy propyl methyldimethoxysilane, 3-methacryloxy propyl trimethoxy silane, 3-methacryloxy propyl methyldiethoxysilane, 3-methacryloxy triethoxysilane, 8-methacryloxy octyl trimethoxysilane, 3 acryloxy propyl trimethoxysilane, N-2-(aminoethyl)-3-aminopropylmethyldimethoxysilane, N-2-(aminoethyl)-3-aminopropyltrimethoxysilane, 3-aminopropyltriethoxysilane, 3-aminopropyltrimethoxysilane, N-2-(aminoethyl)-8-aminooctyltrimethoxysilane, 3-trimethoxysilypropyldiethylenetriamine, bis-(3-trimethoxysilylpropyl)amine, 4-amino-3,3-dimethylbutyltrimethoxysilane, 3-aminopropylmethyldiethoxysilane, 3-aminopropylmethyldimethoxysilane, 3-trimethoxysilyl)propylsuccinic anhydride, 3-mercaptopropyltrimethoxysilane, 3-mercaptopropylmethyldimethoxysilaneoxysilane and combinations thereof.

13. A method for forming the composition of claim 1, comprising
a) providing a fluoropolymer-acrylic hybrid composition containing functional groups,
b) dissolving the fluoropolymer-acrylic hybrid composition in solvent,
c) introducing a silane into the dissolved fluoropolymer-acrylic hybrid composition, optionally in the presence of a catalyst,
and recovering the silane functionalized fluoropolymer-acrylic hybrid composition.
wherein the silane functionalized fluoropolymer-acrylic hybrid composition comprising from 5 to 30 wt % acrylic monomer units based upon the total weight of the silane functionalized fluoropolymer-acrylic hybrid composition, wherein the fluoropolymer-acrylic hybrid composition is a composition comprising an acrylic monomer polymerized with a fluoropolymer seed.

14. The method of claim 13, wherein the solvent is selected from the group consisting of n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC), ethyl methyl carbonate (EMC) and combinations thereof.

15. The method of claim 13, wherein the acrylic portion contains monomer selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate, allyl glycidyl ether, methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (meth)acrylate; and combinations thereof.

16. The method of claim 13, wherein the silane functionalized fluoropolymer-acrylic hybrid composition is self cross-linking.

17. The method of claim 13, comprising the step of adding a cross-linking agent.

18. The method of claim 17, wherein the crosslinking agent is selected from the group consisting of isocyanate, diamine, adipic acid, dihydrazide and combinations thereof.

19. The composition of claim 1 wherein the composition is crosslinked.
